(19) United States
(12) Patent Application Publication
(10) Pub. No.: US 2009/0184602 A1
(43) Pub. Date: Jul. 23, 2009

(54) Permanent-Magnet Synchronous Machine with Suppression Means for Improving the Torque Ripple

(75) Inventors: Matthias Braun, Massbach (DE); Holger Schunk, Lendershausen (DE); Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/575,718

(22) PCT Filed: Sep. 16, 2005
(86) PCT No.: PCT/EP05/54622

§ 371 Date: Mar. 21, 2007

(30) Foreign Application Priority Data
Sep. 22, 2004 (DE) 10 2004 045 939.8

(51) Int. Cl. H02K 1/16

(52) U.S. Cl. 310/216.112

(57) ABSTRACT

The invention relates to a permanently excited synchronous machine (1) comprising a stator (2) provided with slots (5) and a rotor (3) provided with permanent magnets (9) which form a magnetic pole (10). The machine also comprises first suppression means in the form of a pole covering (x) which is smaller than one in relation to a pole distribution (tp) of the permanent magnets (9), second suppression means in the form of a first staggering of the permanent magnets of a pole or a first inclination of the permanent magnets or a first inclination (α_{Schi}) of the slots (5), and third suppression means in the form of a second staggering (αₛₜ₂) of the permanent magnets (9) of a pole (10) or a second inclination (α_{Sch2}) of the permanent magnets (9) or a second inclination of the slots.

The invention relates to a permanent-magnet synchronous machine with a stator provided with slots and with a rotor provided with permanent magnets, which form magnetic poles.

Such a permanent-magnet synchronous machine often has a certain degree of torque ripple during operation. In order to reduce this torque ripple, various suppression means are known. For example, DE 100 41 329 A1 discloses that a pole coverage of the surface of the rotor with permanent magnets of from 70 to 80% results in an improved harmonic field response. In addition, DE 199 61 760 A1 has disclosed that special winding factors of a winding system arranged in the slots and a skew of the slots results in a reduction in the torque ripple. Despite these known measures, the torque ripple still exists, in particular when there is at the same time the demand for production of the permanent-magnet synchronous machine which is as inexpensive as possible.

The object of the invention therefore consists in specifying a permanent-magnet synchronous machine of the type mentioned at the outset which has a further improved torque response with as little ripple as possible.

This object is achieved by the features of independent patent claim 1. The permanent-magnet synchronous machine described at the outset is one in which
a) first suppression means in the form of a pole coverage, which, based on a pole pitch of the permanent magnets, is less than one,
b) second suppression means in the form of a first staggering of the permanent magnets of one pole or a first skew of the permanent magnets or a first skew of the slots, and
c) third suppression means in the form of a second staggering of the permanent magnets of one pole or a second skew of the permanent magnets or a second skew of the slots
   are provided.

It has been identified that the torque ripple can be attributed to various causes. The cause of a first component is the reluctance forces between the permanent magnets of the rotor and the teeth, which are provided between the slots. This component brings about cogging and results in oscillating torques. Interactions between the rotor and stator magnetic field waves are further causes of the torque ripple. In this regard, in particular the fifth and the seventh harmonics to the fundamental of the air gap field present in the air gap between the rotor and the stator are significant. Overall, with the cogging, the fifth and the seventh harmonics in the air gap field, three main sources of the torque ripple can therefore be found. According to the invention, special suppression means are provided for reducing each of the mentioned three main causes as efficiently as possible. The suppression means can then be matched in a very targeted manner to the respectively critical cause of the torque ripple. As a result, considerably improved suppression of the torque ripple can be achieved.

Advantageous configurations of the permanent-magnet synchronous machine according to the invention can be gleaned from the features in the claims dependent on claim 1.

A pole coverage of ⅘, i.e. of 80%, is used in particular to suppress the fifth harmonic to the fundamental of the air gap field. Accordingly, the seventh harmonic can be suppressed by a pole coverage of 6/7, i.e. of approximately 85.7%.

A favorable variant is one in which the second suppression means is in the form of a first staggering of the permanent magnets of one pole, and the third suppression means is in the form of a second staggering of the permanent magnets of one pole. This results in a double staggering at a first and a second staggering angle. Both staggerings can be produced by means of an arrangement of the permanent magnets which is offset corresponding to the respective staggering angle. The manufacturing complexity required for the double staggering is not substantially greater than that for single staggering. Nevertheless, effective suppression of two main sources of the torque ripple, for example the cogging and one of the two particularly disruptive harmonics mentioned, is achieved by means of the double staggering. A double staggering can also be realized exclusively by intervention on the rotor, with the result that no additional manufacturing complexity is required for the stator.

Furthermore, with a double staggering provision can be made for the permanent magnets of one pole, irrespective of their respective assignment to the first or second staggering, to be arranged in the axial direction with an increasing offset of the circumferential angle in relation to the first permanent magnet of this pole. This results in very few stray fields. In addition, the permanent magnets can then be arranged more easily since a situation in which the permanent magnet arrangements of adjacent poles engage in one another virtually does not arise when ordered in this way.

The first or the second skew may be in the form of a simple skew or else in the form of an arrow-like skew. In the case of an arrow-like skew, the permanent magnets or the slots have an arrow shape.

In addition, a double skew with a first and a second skew angle is possible, in which the second suppression means are in the form of a first skew, and the third suppression means are in the form of a second skew. This results in similar advantages to in the case of the double staggering, it being possible for a double skew to be provided both on the rotor and on the stator.

In a further configuration, some of the suppression means can be provided on the stator and some on the rotor. In particular, the second suppression means are provided as the first skew of the slots, and the third suppression means are provided as the second skew or staggering of the permanent magnets. Owing to the measures being split up in this way, simpler manufacture can be achieved, in particular if the physical conditions are tight.

Advantageously, a winding system arranged in the slots contains tooth-wound coils as essential components. Said tooth-wound coils are particularly advantageous in terms of their production costs and their low inductance.

The permanent-magnet synchronous machine may contain an internal or else an external rotor. The measures for suppressing the torque ripple can be used advantageously in both configurations.

Further features, advantages and details of the invention are given in the description below of exemplary embodiments with reference to the drawing, in which:

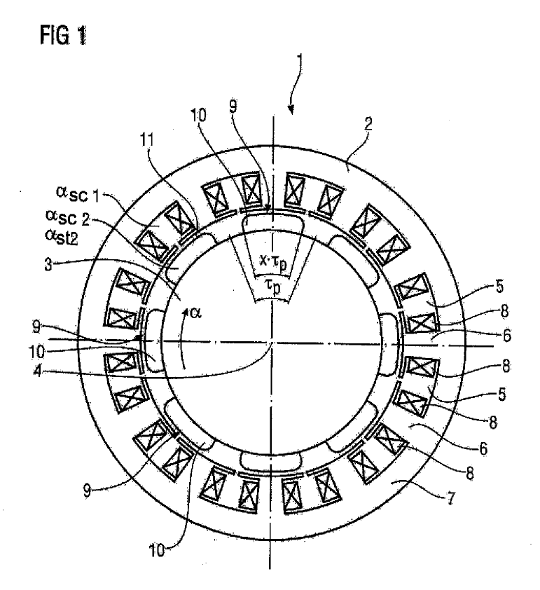

FIG. 1 shows an exemplary embodiment of a permanent-magnet synchronous machine with suppression means in a cross-sectional illustration,

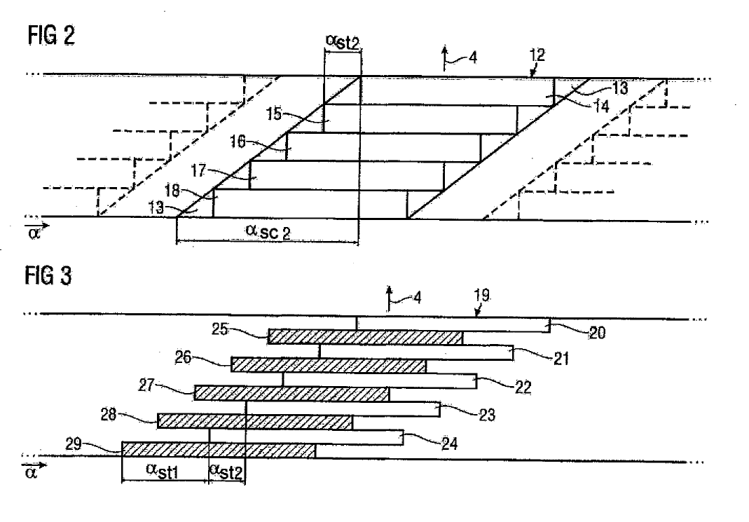

FIG. 2 shows an unrolled surface of two exemplary embodiments of a rotor with skew or staggering of the permanent magnets,

FIG. 3 shows an unrolled surface of a further exemplary embodiment of a rotor with double staggering of the permanent magnets,

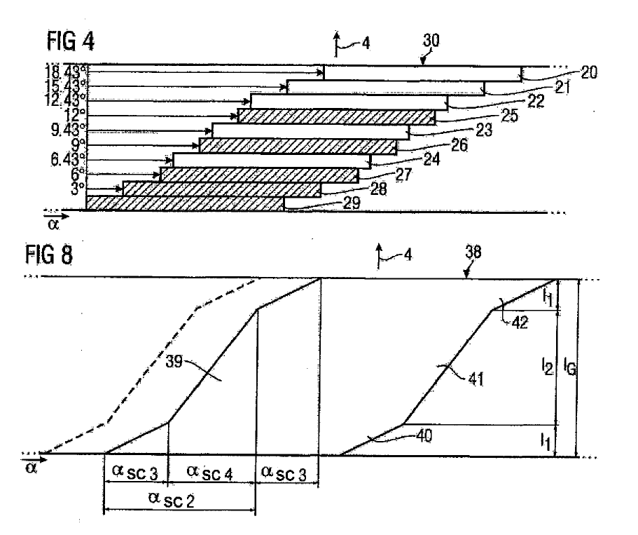

FIG. 4 shows an unrolled surface of a further exemplary embodiment of a rotor with double staggering of the permanent magnets,

FIG. 5 shows the rotor with double staggering as shown in FIG. 4, in a side view,

FIG. 6 shows an unrolled surface of a further exemplary embodiment of a rotor with skew and staggering of the permanent magnets,

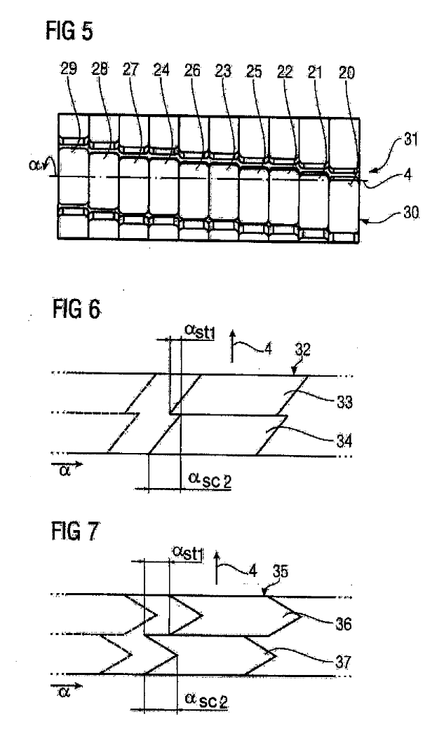

FIG. 7 shows an unrolled surface of a further exemplary embodiment of a rotor with arrow-like skew and staggering of the permanent magnets, and

FIG. 8 shows an unrolled surface of a further exemplary embodiment of a rotor with double skew of the permanent magnets.

Mutually corresponding parts are provided with the same reference symbols in FIGS. 1 to 8.

FIG. 1 shows a permanent-magnet synchronous machine 1 in the form of a motor, in a cross-sectional illustration. It contains a stator 2 and a rotor 3, which is mounted such that it can rotate about an axis of rotation 4. The rotor 3 is an internal rotor. The stator 2 contains a plurality of (in the exemplary embodiment in FIG. 1 in total twelve) slots 5, which are distributed uniformly over the circumference and between which in each case teeth 6 are formed, on its inner wall facing the rotor 3. An outwardly circumferential yoke 7 connects the teeth 6 to one another. Tooth-wound coils 8, which each surround a tooth 6, are arranged in the slots 5. The rotor 3 is provided with permanent magnets 9, which are arranged such that in total eight magnet poles 10 result which are distributed uniformly over the circumference. In this case, a pole pitch τₚ, which is formed by an angular range of a circumferential angle α, is assigned to a magnet pole 10. The permanent magnets 9 extend in the circumferential direction not over the entire angular range of the pole pitch τₚ, but only over part, x·τₚ. The variable x in this case denotes a pole coverage. It has a value of <1.

In order to suppress a torque ripple during operation, the permanent-magnet synchronous machine 1 has various suppression means. In the main, three aspects are responsible for forming the disruptive torque ripple.

Firstly reluctance forces between the permanent magnets 9 and the teeth 6 cause cogging with a cogging pole pair number p_{R}, which is calculated as follows:

p_{R}=kgV(n,2·p).

In this case, kgV represents the least common multiple, n represents a slot number of the slots 5, and p represents a pole pair number of the magnet poles 10. The variable p can also denote the useful pole pair number of a magnetic field established in an air gap 11, which is provided between the stator 2 and the rotor 3. It then reproduces the dominant component of the air gap field, i.e. the fundamental. In the exemplary embodiment with in total eight magnet poles 10, i.e. a pole pair number p=4, and a slot number n=12, a cogging pole pair number p_{R} of 24 results. The permanent-magnet synchronous machine 1 therefore cogs with twice the number of slots n. In addition to this primary cogging, higher-order cogging can be established given any desired multiple of the cogging pole pair number p_{R}.

The other two main causes of the torque ripple are the interactions between the rotor and stator magnetic field waves in the air gap 11. In this case, the fifth and the seventh harmonics to the fundamental of the magnetic air gap field forming in the air gap 11 are particularly disruptive.

Both the cogging and the fifth and the seventh harmonics of the air gap field need to be suppressed in order to ensure as little torque ripple as possible. The permanent-magnet synchronous machine 1 comprises separate and specifically designed suppression means countering each of these three sources of disruption. The slots 5 therefore do not run precisely parallel to the axis of rotation 4, but have a first skew angle α_{sc1}, which reproduces an offset of the circumferential angle. It is calculated as follows:

$${α}_{sch 1} = \frac{i \cdot {360}^{°}}{k \cdot p} , \qquad ( 1 )$$

where i denotes any desired natural number, and k denotes an ordinal number of the harmonic to be suppressed. In the exemplary embodiment, the seventh harmonic is suppressed, i.e. k assumes the value 7. When i=1 and p=4, the first skew angle α_{sch1} of 12.86° results.

The two further suppression means relate to measures provided on the rotor 3. As the second measure for suppressing the fifth harmonic, a value of ⅘ is provided for the pole coverage x. In principle, the first and the second measures can also be interchanged as regards the harmonic to be suppressed.

In addition, as a third measure for suppressing the cogging, the permanent magnets 9 are arranged on the rotor 3 taking into consideration a second skew angle α_{sch2} or a second staggering angle αₛₜ₂. The second skew angle α_{sch2} is calculated as follows:

$${α}_{sch 2} = \frac{i \cdot {360}^{°}}{kg V ( n , 2 \cdot p )} , \qquad ( 2 )$$

and the second staggering angle αₛₜ₂ is calculated as follows:

$${α}_{st 2} = \frac{i \cdot {360}^{°}}{m \cdot ( kg V ( n , 2 \cdot p ) )} , \qquad ( 3 )$$

where m denotes a magnet number of the permanent magnets 9, which are staggered within one magnet pole 10.

The third measure of the skew or staggering of the permanent magnets is illustrated in more detail in FIG. 2. The Figure shows a detail of an unrolled surface of the rotor 3. The illustration essentially reproduces one magnet pole 12. The adjacent magnet poles shown only partially are indicated by dashed lines.

If a skew is provided as the suppression means, the magnet pole 12 contains only a single permanent magnet 13 in the form of a parallelogram. The second skew angle α_{sch2} is illustrated. It corresponds to a section of the circumferential angle α, which results from a distance between the left-hand, lower corner and a vertical of the left-hand upper corner onto the connecting line between the two lower corners. When i=1, n=12 and p=4, the second skew angle α_{sch2} in accordance with equation (2) in the exemplary embodiment of 15° results.

As an alternative to this skew, a staggering can also be used. In this case, the parallelogram of the permanent magnets 13 is approximated by a plurality of, in the exemplary embodiment shown by in total five, rectangular permanent magnets 14, 15, 16, 17 and 18 of equal length. The permanent magnets 14 to 18 are staggered and are in each case offset with respect to the adjacent one of the permanent magnets 14 to 18 by the second staggering angle αₛₜ₂ in the circumferential direction. When m=5, the second staggering angle αₛₜ₂ is calculated as 3° in accordance with equation (3).

The two alternatives shown in FIG. 2 each counteract the cogging, the skew bringing about suppression of the fundamental and all multiples of the cogging. On the other hand, the staggering does not ensure any suppression of harmonics with an ordinal number corresponding to the magnet number m and its multiples. In order to suppress the lower-order harmonics, which are generally only slightly attenuated, a magnet number m of at least three, preferably of at least four, is therefore provided. In the example, m=5. The rectangular permanent magnets 14 to 18 can be produced more easily, for which purpose the permanent magnet 13 in the form of a parallelogram provides suppression of all harmonics of the cogging.

In a further exemplary embodiment of a permanent-magnet synchronous machine, the slots 5 in the rotor 3 do not have a skew, but run essentially parallel to the axis of rotation 4. All of the measures for suppressing the three main causes of the torque ripple are then provided on the rotor 3. Such exemplary embodiments are illustrated in FIGS. 3 to 7.

In FIG. 3, a detail, which comprises a magnet pole 19, of an unrolled surface of the rotor 3 with double staggering is shown. The starting point is the single staggering provided in the exemplary embodiment in FIG. 2 with the five permanent magnets 14 to 18. If the five permanent magnets 14 to 18 are halved in the direction of the axis of rotation 4 and in each case the lower half is displaced with respect to the associated upper halves in the circumferential direction through a first staggering angle αₛₜ₁, the arrangement shown in FIG. 3 results. The lower halves, which have been displaced towards the left, are illustrated by hatching for reasons of clarity. The magnet pole 19 then comprises in total ten rectangular permanent magnets 20 to 29, which are arranged with double staggering at the first staggering angle αₛₜ₁ and the second staggering angle αₛₜ₂. The first staggering angle αₛₜ₁ is calculated as follows:

$${α}_{st 1} = \frac{i \cdot {180}^{°}}{k \cdot p} , \qquad ( 4 )$$

and the second staggering angle αₛₜ₂ is calculated in accordance with equation (3). When i=1, the pole pair number p=4, the ordinal number of the harmonic to be suppressed k=7, the magnet number m=5 and the slot number n=12, the first staggering angle αₛₜ₁ of 6.43° and the second staggering angle αₛₜ₂ of 3° result. The first staggering angle αₛₜ₁ counteracts the seventh harmonic, the second staggering angle αₛₜ₂ counteracts the cogging, and the pole coverage (not shown in any more detail in FIG. 3) x=⅘ counteracts the fifth harmonic. Overall, the torque ripple is thereby considerably reduced.

The exemplary embodiment in FIG. 4 with a magnet pole 30 illustrated is modified in comparison with the exemplary embodiment in FIG. 3 insofar as the permanent magnets 20 to 29 are reordered such that their respective offset of the circumferential angle in relation to the first permanent magnet 29 increases in the direction of the axis of rotation 4. The respective offsets of the circumferential angle are included in FIG. 4.

FIG. 5 shows a side view of an associated rotor 31, on which the permanent magnets 20 to 29 of the magnet pole 30 are arranged in a reordered sequence as magnet shells. In addition to a corresponding pole coverage, the rotor 31 therefore also contains a double staggering in order to minimize the torque ripple.

Instead of a double staggering, a combination of a skew and a staggering is also possible. Exemplary embodiments in this regard are shown in FIGS. 6 and 7.

The exemplary embodiment shown in FIG. 6 contains a magnet pole 32 and is based on the skew shown in FIG. 2 with the permanent magnet 13 in the form of a parallelogram. An upper and a lower permanent magnet 33 and 34, respectively, which are in the form of parallelograms and are arranged such that they are offset with respect to one another through the first staggering angle αₛₜ₁ in accordance with equation (4), result by means of the permanent magnets being split in two. Each of the two permanent magnets 33 and 34 has a second skew angle α_{sch2}, which has been calculated in accordance with equation (2).

The exemplary embodiment shown in FIG. 7 contains a magnet pole 35 with an in principle comparable design. Instead of the permanent magnets 33 and 34 in the form of parallelograms, in this exemplary embodiment two arrow-shaped permanent magnets 36 and 37 are provided, which are in turn arranged such that they are offset with respect to one another through the first staggering angle αₛₜ₁. As can be seen in FIG. 7, the second skew angle α_{sch2} is determined by the projection of the arrow tip at the front end or by the depth of the notch at the rear end of the permanent magnets 36 and 37.

In principle, an arrow-like skew, such as is provided in the case of the permanent magnet 36 or 37, can also be used in the case of the slots 5 in the stator 2.

On the basis of the exemplary embodiment in FIG. 4 or FIG. 6, a further exemplary embodiment can be specified with a magnet pole 38, which contains a permanent magnet 39 having a double skew. Said permanent magnet 39 comprises three magnet subregions 40, 41 and 42 in the form of parallelograms. In each case a first skew angle α_{sch3} is assigned to the first and the third magnet subregion 40 and 42, respectively, a second skew angle α_{sc4} being assigned to the second magnet subregion 41, however.

The first skew angle α_{sch3} is calculated as follows:

$${α}_{sch 3} = \frac{{360}^{∘}}{k \cdot 4 \cdot p} , \qquad ( 5 )$$

and the second skew angle α_{sch4} is calculated as follows:

α_{sch4}=α_{sch2}−α_{sch3} (6),

where the further skew angle α_{sch2} is based on the equation (2). The first and the third magnet subregions 40 and 42 each have a subregion length l₁, in the direction of the axis of rotation 4, of:

$${l}_{1} = \frac{1}{2} \cdot {l}_{T} \cdot \frac{{α}_{sch 3}}{{α}_{sch 2}} , \qquad ( 7 )$$

where I_{T} denotes the total length of the permanent magnet 39 in the direction of the axis of rotation 4. The second magnet subregion 41 has a subregion length l₂ of:

l₂=l_{T}−2·l₁ (8).

By means of the double skew in accordance with the exemplary embodiment in FIG. 8, the influence of a harmonic and the cogging is suppressed.

The permanent magnet 39 can be designed integrally, as shown in FIG. 8, or else designed to comprise a plurality of parts, for example corresponding to it being split into the three magnet subregions 40 to 42. In addition, the double skew, which is illustrated in FIG. 8 for the fitting of a permanent magnet 39 to a rotor (which is not illustrated in any more detail), can also be used in principle for the slots 5 of the stator 2.

Overall, very efficient suppression of the torque ripple can be achieved using the described combinations of in each case three measures.

1.-15. (canceled)

16. A permanent-magnet synchronous machine, comprising:
a stator having slots;
a rotor having permanent magnets which form magnetic poles;
first suppression means in the form of a pole coverage, which, based on a pole pitch of the permanent magnets, is less than one;
second suppression means in the form of a first staggering of the permanent magnets of one pole at a first staggering angle; and
third suppression means in the form of a second staggering of the permanent magnets of one pole at a second staggering angle, thereby providing a double staggering,
wherein the permanent magnets of one pole, irrespective of their association to the first or second staggering, are arranged, reordered, in an axial direction with an increasing offset of a circumferential angle in relation to a first permanent magnet of this pole, and
wherein the first staggering angle assumes a value according to the equation:
$${α}_{st 1} = \frac{i \cdot {180}^{°}}{k \cdot p} ,$$
with αₛₜ₁ denoting the first staggering angle,
i denoting a random natural number greater than zero,
k denoting an ordinal number of a harmonic to be suppressed in the torque of the synchronous machine, and
p denoting a pole pair number.

17. The permanent-magnet synchronous machine of claim 16, wherein the second staggering angle assumes a value according to the equation:
$${α}_{st 2} = \frac{i \cdot {360}^{°}}{m \cdot ( kg V ( n , 2 \cdot p ) )} ,$$
wherein
α_{St2} denotes the second staggering angle,
i denotes a random natural number greater than zero,
m denotes a magnet number of permanent magnets of the first or second staggering,
kgV denotes a least common multiple,
n denotes a slot number of the slots in the stator, and
p denotes a pole pair number.

18. The permanent-magnet synchronous machine of claim 17, wherein the magnet number is at least three.

19. The permanent-magnet synchronous machine of claim 17, wherein the magnet number is at least four.

20. The permanent-magnet synchronous machine of claim 16, wherein the pole coverage is ⅘.

21. The permanent-magnet synchronous machine of claim 16, wherein the pole coverage is 6/7.

22. The permanent-magnet synchronous machine of claim 16, wherein the slots accommodate a winding system, and the winding system contains tooth-wound coils.

23. The permanent-magnet synchronous machine of claim 16, wherein the rotor is constructed in the form of an external rotor.

24. The permanent-magnet synchronous machine of claim 16, wherein the rotor is constructed in the form of an internal rotor.

25. A permanent-magnet synchronous machine, comprising:
a stator having slots;
a rotor having permanent magnets which form magnetic poles;
first suppression means in the form of a pole coverage, which, based on a pole pitch of the permanent magnets, is less than one;
second suppression means in the form of a first skew of the permanent magnets of one pole at a first skew angle; and
third suppression means in the form of a second skew of the permanent magnets of one pole at a second skew angle, thereby providing a double skew,
wherein each of the poles has first, second and third magnet subregions in the form of parallelograms, with the first skew angle being assigned to the first and third magnet subregions, and the second skew angle being assigned to the second magnet subregion, and
wherein the first skew angle is governed by the equation:
$${α}_{sch 3} = \frac{{360}^{°}}{k \cdot 4 \cdot p} ,$$
and the second skew angle is governed by the equation:
α_{sch4}=α_{sch2}−α_{sch3},
wherein
α_{sch3} denotes the first skew angle,
α_{sch4} denotes the second skew angle,
k denotes an ordinal number of a harmonic to be suppressed in the torque of the synchronous machine,
p denotes a pole pair number, and
α_{sch2} denotes a further skew angle, which is governed by the equation:
$${α}_{sch 2} = \frac{i \cdot {360}^{∘}}{kg V ( n , 2 \cdot p )} ,$$
wherein
i denotes a random natural number greater than zero,
kgV denotes a least common multiple, and
n denotes a slot number of the slots in the stator.

26. The permanent-magnet synchronous machine of claim 25, wherein the pole coverage is ⅘.

27. The permanent-magnet synchronous machine of claim 25, wherein the pole coverage is 6/7.

28. The permanent-magnet synchronous machine of claim 25, wherein the slots accommodate a winding system, and the winding system contains tooth-wound coils.

29. The permanent-magnet synchronous machine of claim 25, wherein the rotor is constructed in the form of an external rotor.

30. The permanent-magnet synchronous machine of claim 25, wherein the rotor is constructed in the form of an internal rotor.
